(19) United States
(12) Patent Application Publication
(10) Pub. No.: US 2010/0033813 A1
(43) Pub. Date: Feb. 11, 2010

(54) 3-D Display Requiring No Special Eyewear

(76) Inventor: Gerald L. Rogoff, Framingham, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/392,197

(22) Filed: Feb. 25, 2009

Related U.S. Application Data
(60) Provisional application No. 61/086,324, filed on Aug. 5, 2008.

(51) Int. Cl. G02B 27/22; H04N 13/04

(52) U.S. Cl. 359/463; 348/54; 348/E13.001; 359/462

(57) ABSTRACT

A display system enables viewing a stereo pair of images without any special eyewear. In one embodiment an array of micro-lens elements are mounted in front of a pixel-based image display. Lens elements in the micro-lens array can have differing fixed optical properties and in one embodiment the micro-lens array can have differing focal lengths to provide flexibility as to the location of a viewer, reduced optical distortion, and more comfortable viewing due to balanced horizontal and vertical resolution.

### CROSS REFERENCE TO RELATED APPLICATIONS

The present application claims the benefit of U.S. Provisional Patent Application No. 61/086,324 filed on Aug. 5, 2008, which is incorporated herein by reference in its entirety.

### BACKGROUND

Numerous 3-D viewing concepts and devices have been developed over many years. Many of those approaches require the viewer to wear special 3-D viewing glasses or goggles or to view images through fixed eyepieces. Autostereoscopic (i.e., not requiring any special eyewear) display approaches have been developed. Autostereoscopic display approaches include holography, volumetric imaging, and multiple-image techniques such as integral imaging (“fly's eye” type lens arrays with each lens displaying its own complete image), light barriers containing slits through which light can pass at specific angles for viewing different images from different directions, and lenticular lens arrays. Holography, while fundamentally capable of producing highly realistic 3-D images, has not been developed beyond a rudimentary level for general 3-D viewing.

While someday a 3-D display may be available providing an autostereoscopic electronic display to an arbitrary number of freely-moving viewers located at arbitrary viewing angles and distances with smooth parallax and head-tipping for such uses as general-purpose TV viewing, there presently appears to be a vast potential commercial market for single-viewer 3-D television and personal computer applications.

One autostereoscopic technology that has received considerable attention is lenticular 3-D. A lenticular 3-D display basically consists of a series of cylindrical lenses located in front of a surface containing the image to be viewed. The cylindrical lenses in the lenticular sheet are adjacent to each other, parallel to each other, and typically vertically-oriented. The display surface containing the image to be viewed lies in the focal plane of the lenses.

Another technology, integral imaging, is essentially a photographic technique, although in some cases an electronic sensor sheet is used instead of photographic film. Each lens in a two-dimensional lens array records and displays its own unique view of a common scene, and does not image only a small element of a scene such as one or two pixels.

### SUMMARY

Conventional autostereoscopic displays have one or more of the following significant disadvantages: they restrict the viewed image to be located inside a limited volume; they are large, non-flat systems; they are highly complex and costly; and some systems require eye-tracking (i.e., the system tracks the locations of the viewers' eyes in order to direct different scenes precisely to the two eyes—or to more than two eyes for multiple viewers); intensive computing; and large data storage capability.

Conventional autostereoscopic lenticular display systems suffer from a number of additional deficiencies. Among the problematic issues are moire effects and other related effects. Another problem with the lenticular system is the imbalance between the horizontal and vertical resolutions, which produces some viewing discomfort. Lenticular 3-D displays also suffer from optical problems such as image distortion resulting from misalignment of lenticular arrays of cylindrical lenses. Generally, practical lenticular display systems cannot provide satisfactory 3-D display quality. This quality degradation is mainly due to two major problems, one that is intrinsic and the other extrinsic. Intrinsically, rays from a viewer's eye to the lenticulae placed on a display panel are not parallel to each other. However, a practical system may assume parallel rays for ease of manufacturing, thereby causing undesirable display distortion. The extrinsic problem is that lenticular arrays of cylindrical lenses may not be precisely aligned on the display panel, especially when lenticulae are slanted to solve the imbalance problem between horizontal and vertical resolutions. This alignment error causes considerable distortions in the 3-D display.

A technique for presenting a 3-D display includes the steps of providing a micro-lens array having a plurality of elements directing the outputs from respective pixel groups in mutually different directions and wherein at least two elements in the micro-lens array have a differing fixed optical property as a function of the distance of an object plane including a pixel group dividing line from a corresponding element of the micro-lens array, and an image-plane distance from the corresponding element and providing an stereoscopic image in disposed proximate to the micro-lens array, wherein the image provides a first eye perspective view and a second eye perspective view.

There are many possible applications of this new personal 3-D display. Exemplary applications include computer screens, control systems, medical displays (both for diagnostics and for operating-room use by surgeons), cellular telephone displays, various handheld wireless Internet devices, portable DVD players, personal-size TVs and electronic game players. Potential users include: researchers, designers, scientists, surgeons, teachers, cartographers, and the military for reconnaissance and other applications—as well as the public for general viewing and game playing. For many currently popular applications, the present invention appears to be a practical, relatively inexpensive, technologically feasible and sensible approach for high-quality three-dimensional viewing. Aspects of the invention offer a simple, effective means for satisfying the demand both for specialized and mass-market applications.

The added micro-lens array represents a relatively minor item of additional hardware. The display can be monochromatic or multi-color. For a monochromatic display, each pixel will exhibit some shade of the display's single color, say a shade of grey for a black-and-white display. In presently available color displays, each pixel contains three separate small color elements that together form the intended perceived image color at that pixel location. Embodiments of the invention can utilize both types of display.

There are fundamental differences between the type of lens used in a lenticular 3-D system and the type used in embodiments of the present invention. The basic optical characteristics of a cylindrical lens in lenticular 3-D systems are defined only in a plane perpendicular to the cylinder axis. With an optical object located in the focal plane of a cylindrical lens (i.e., at the focal distance from the front surface of the vertically-oriented lens) the image of that object in the horizontal plane is located at infinity. That is, for each point in the optical object, the rays emanating from that point in a horizontal plane emerge from the lens in that same plane and are directed parallel to each other in a particular direction in that plane. For rays not lying in the horizontal plane, the optical characteristics are not clearly defined. There is no focusing action by the lens; refraction at the lenticular lens surface directs the rays somewhere between the horizontal and vertical. The rays in a lenticular 3-D system are spread vertically over a large angle. In contrast, lenses in embodiments of the present invention form images at finite distances and controlled locations.

As described by G. L. Rogoff in “Optical System for Spatial Discrimination of Radiation from Extended Bodies,” Applied Optics, vol. 8, pp. 723-724 (1969)), a lens with an object at a focal length distance from the lens, a telescopic system, is primarily a directional device; it primarily determines the direction of rays that originate from points in its focal plane. It is not a device for forming images at finite distances. For a cylindrical lens, a rotational alignment error will distort the image. Rotation of a lens in the present invention will not distort the image. The optical characteristics of the lens elements in the present invention are rotationally symmetric about the optical axis of the lens.

For a lens element in the present invention, the optical characteristics are well defined both horizontally and vertically. Since the optical object is not located in the focal plane of the lens, the image of that object is at a finite and controlled distance from the lens. The light from a pixel is focused in both the horizontal and vertical directions to form an image in the viewing region.

Embodiments of the inventive display provide a new three-dimensional display intended for use by a single viewer. Additional viewers could view at the same time, but they would view in two dimensions rather than three; three-dimensional viewing by multiple viewers requires multiple displays. However, for the viewer viewing in 3-D no glasses are required, and the viewer's head need not be held in a fixed position; the head can be moved horizontally both parallel to the display surface and perpendicular to it to some extent while retaining the 3-D view. Horizontally, parallel to the display surface, the head can be moved a distance equal to the distance between the eyes. Some head movement is allowed vertically as well. This display system offers a degree of 3-D viewing comfort not found with long-term use of special glasses, goggles, eyepieces or any other special eyewear.

In one embodiment an autostereoscopic display apparatus includes an image display for providing a display output comprising a plurality of pixels grouped in a row and column array, a micro-lens array disposed adjacent the image display, having a plurality of elements directing the outputs from respective pixel groups in different directions so as to enable a stereoscopic image to be perceived and at least two elements in the micro-lens array have a differing fixed optical property as a function of a distance from an object plane including a pixel group dividing line to a center point of the corresponding element of the micro-lens array along the optical axis, and an image-plane distance from the corresponding element. Such a display provides 3-D viewing for a single viewer, without any special eyewear and with some flexibility as to the location of the viewer.

Further advantages over conventional lenticular 3-D displays include, but are not limited to: better resolution by avoiding vertical spreading of emitted light as in lenticular displays; more comfortable viewing by avoiding problems of visually uncomfortable imbalance between the horizontal and vertical resolutions of lenticular systems; brighter display image because light from the display surface is concentrated horizontally and vertically into the viewing region; avoidance of a Moire effect associated with aligning sets of linear objects; and less sensitivity to misalignment because lens rotation does not distort the image.

In another embodiment, a 3-D display includes an array of pixel pairs, each pixel pair including at least one first pixel and at least one second pixel, an array of lenses disposed in front of the array of pixel pairs, each lens in the array of lenses aligned with a respective pixel pair and configured with a focal pattern such that a first image of a first pixel of one of the pixel pairs is projected into a first viewing area and second image of a second pixel of the same one of the pixel pairs is projected into a second viewing area. The first viewing area being a first location for viewing by a respective one of a viewer's left and right eye and the second viewing area being a second location for viewing by the viewer's other eye.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a view showing a display system including a display panel and incorporating a micro-lens array according to one embodiment of the invention.

FIG. 2 is a schematic diagram showing the paths of light directed from the display panel to a viewer for the system of FIG. 1;

FIG. 3 is a schematic diagram of the top view of a horizontal cross section plane containing the perpendicular to the display surface and the common image point showing optical paths of the system of FIG. 2;

FIG. 4A shows a pixel pair-lens alignment where the pixel pairs and lenses of the micro-lens array are aligned vertically according to one aspect of the invention; and

FIG. 4B shows a pixel pair-lens alignment where the pixel pairs and lenses of the micro-lens array are staggered vertically according to one aspect of the invention.

### DETAILED DESCRIPTION

In one embodiment, the autostereoscopic display apparatus disclosed herein provides a 3-D display comprising a plurality of pixel groups arranged in a row and column array. Each pixel group is a pixel pair including at least one first pixel and at least one second pixel. As an example, the first and second pixels of each pixel group can be disposed side by side one another. An array of micro-lens elements is provided and is disposed in front of the array of pixel pairs. In one configuration, each lens in the array of lenses is aligned with a respective pixel pair to allow focusing of imagery produced from that pixel pair. Specifically, each lens in the array of lenses is configured with a focal pattern that projects an image of the first pixel of a pixel pair in a first viewing area to enable the first pixel to be viewable, for example by one of a left and a right eye of a viewer. That same lens projects an image of the second pixel of that same pixel pair in a second viewing area to enable the second pixel to be viewable by the other of the right and left eye of the same viewer. In this manner, the first viewing area (i.e., the images from all first pixels of all pixel pairs on a display) is perceived by a respective one of a viewer's left and right eye and the second viewing area that includes or contains the projected images of the other pixels of the pixel pairs is perceived by the viewer's other eye. Thus each micro-lens element projects the images of the first and second pixels (there may be more than one first pixel and more than one second pixel, and hence the term pixel group is not limited to just two pixels) into two viewing areas each utilized by a respective eye of a viewer viewing the display. In this manner, image signals sent to each first pixel of each pixel pair collectively combine to form an image viewed by the right eye of a viewer, while images sent to each second pixel of each pixel pair collectively form an image viewed by the left eye of the viewer. In this manner, the two images (one being sent as a signal to all first pixels, and the other being sent as a signal to all second pixels) can be viewed as a 3-D image by the viewer.

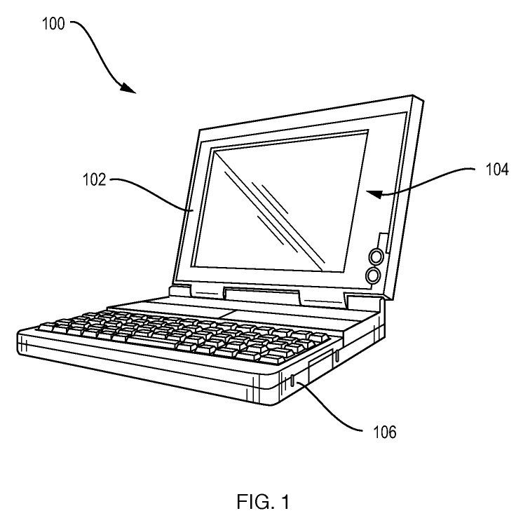

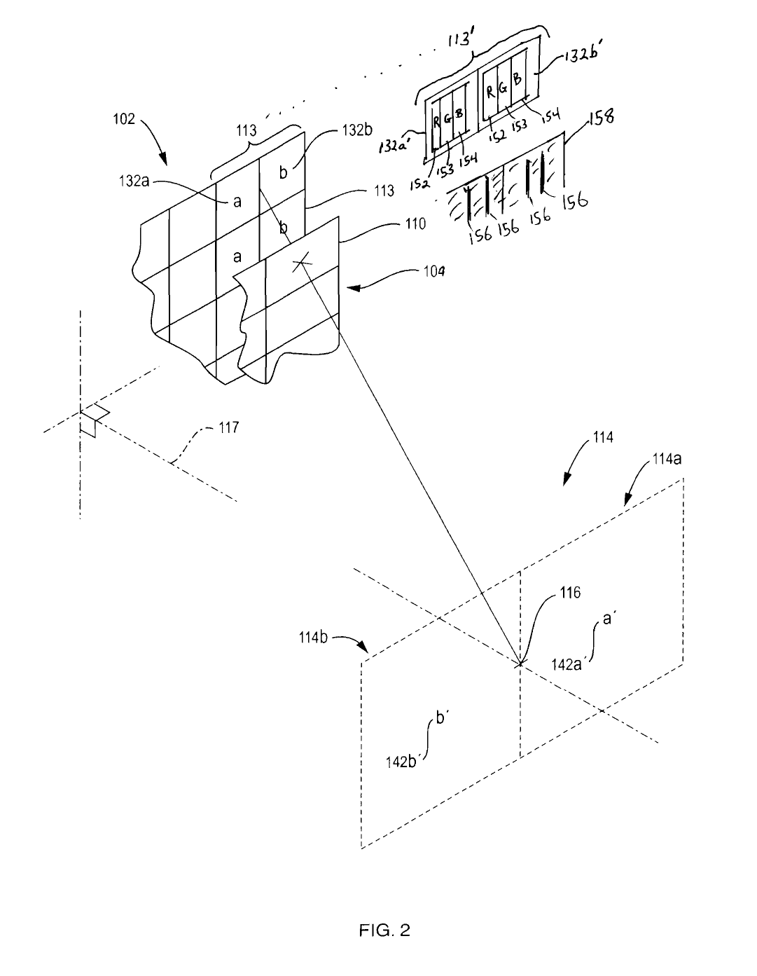

Now referring to FIG. 1, autostereoscopic display apparatus 100 includes an image display 102 and a micro-lens array 104 disposed adjacent to the image display 102. In one embodiment, the image display 102 is, for example, a liquid crystal display panel (shown here as part of a laptop computer 106) and the micro-lens array 104 is, for example, a glass micro-lens array. It is understood that the micro-lens array 104 could also be made of plastic or other suitable material as is know in the art. It is further understood that the lens elements of the micro-lens array 104 in most embodiments are adjacent to but are not in contact with the image display 102. The micro-lens array 104 can be constructed and mounted in various ways. The micro-lens array 104 can, for example, be in the form of a sheet of lenses attached to the front of the display 102. The sheet may be made by molding or pressing as a unit. In one embodiment, high-quality optics are not required in the micro-lens array 104 to obtain high-quality viewed images. High-quality lenses and high-quality images of the pixels are not required because each lens element is imaging only the areas of two pixels, each of which is simply a region of a single color. What is important is that one set of pixels is seen only from one side of a common image point 116 (as described below in conjunction with FIG. 2) and the other set of pixels is seen only from the other side of the common image point 116. Each lens determines from which side of the common image point a pixel can be seen. The quality of the overall viewed picture is determined by the quality of the underlying display unit, not by the quality of the individual pixel images formed by the lens array.

In one embodiment the display surface does not lie in the focal plane of any of the micro-lens elements. Also note that each pixel-lens combination is an independent optical system with its exit pupil located where the eyes are expected to be located. All the independent exit pupils overlap, with all having in common at least the common image point along the perpendicular from the display surface center.

In one embodiment, the micro-lens array 104 is retrofitted to an available conventional display unit or it can be partially or fully integrated with the image display 102. The micro-lens array 104 may be added to a display in various ways. For example in one embodiment, the micro-lens array 104 is mounted with separate spacers between the micro-lens array 104 and the surface of the image display 102; or the micro-lens array 104 may be constructed with built-in spacers extending to the surface of image display 102 to contact the surface of image display 102 directly in selected regions; or the micro-lens array 104 may be constructed with its side that faces the image display 102 made entirely flat (or curved) to contact the surface of image display 102 directly everywhere. In the latter case the side of the micro-lens array 104 facing away from the surface of image display 102 would be suitably shaped to provide the optical imaging required for this invention. The micro-lens array 104 can be retrofitted to an existing display or can be fabricated as an integral part of a display. For example, image display 102 front outer layer and the micro-lens array 104 can be constructed as a single unit. To achieve a flat outer surface, the micro-lens array 104 may be shaped only on its surface facing toward the surface of image display 102.

For clarity, aspects of the invention will be described first as a monochromatic black-and-white version. Color displays with each pixel group including three distinct colors are discussed further below. Now referring to FIG. 2, a schematic view of a portion of autostereoscopic display apparatus 100 shows a perspective view of a portion of a surface of image display 102 and a portion of the micro-lens array 104. The image display 102 includes a plurality of pixels grouped in a row and column array, here shown as pixel pairs 113. The micro-lens array 104 includes an array of elements 110. In FIG.2, perpendicular line 117 extends from approximately the center of the display 102 surface to a common image point 116 where the outputs are directed from respective pixel groups 113 in different directions so as to enable a stereoscopic image to be perceived in viewing region 114 including viewing area 114a to be perceived by a viewer's right eye, and viewing area 114b to be perceived by a viewer's left eye. In one embodiment, each lens element 110 in the micro-lens array 104 is shaped, positioned, and oriented to form an image of each pixel group 113 (here side-by-side pixels a and b) along the perpendicular 117 in the viewing region 114 (as imaged pixels a′ and b′). The plurality of elements 110 direct the outputs from respective pixel groups 113 in different directions so as to enable a stereoscopic image to be perceived.

By providing a display 102 such as a laptop computer display, television display, or other video display in conjunction with the micro-lens array 104 disposed in front of groups of pixel pairs 113 on the display 102, and configuring the elements of the micro-lens array 104 to project images of half the pixels of the display (i.e., all first pixels of the pixel pairs) to a viewing area 114a for a viewer's right eye, and to project images of the other pixels to a viewing area 114b for the viewer's left eye, 3-D imagery (i.e., two distinct images) can be provided. As a viewer views the display 102, the right eye viewing area 114a is a region in which imagery from all first pixels is projected by the set of lens elements, and the left eye viewing area 114b is a region in which imagery from all second pixels is projected. By carefully aligning each element 110 of the micro-lens array 104, when a viewer positions his or her head in front of the display in a top-to-bottom and left-to-right centered manner, so long as the viewer's right and left eyes are located within each of the two different viewing areas in the viewing region 114, the viewer can experience 3-D imagery. Slight movement of the viewer's head is allowed while still perceiving the 3-D effect, so long as the viewer's right and left eyes do not move so much as to cause the right or left eye to stray (from head movement) into the first or second viewing area intended to be utilized by the other eye. If this occurs, the viewer can still view the display but the 3-D effect will be lost until their head moves back to a position in which each eye is capturing imagery from its respective first or second viewing area. The viewing areas 114a and 114b are thus regions in space into which the lens elements 110 project pixel images and in which a viewer's left and right eyes must respectively be located to perceive the images in a 3-D effect.

In one embodiment, two abutting pixels side-by-side form a pixel group behind each lens element. To distinguish between the two pixels associated with a given lens element, the pixel on the left side of their abutting line (facing the display surface) is referred to as pixel “a” 132a and the pixel on the right side will be called pixel “b” 132b in the following explanation. The distance, position and orientation of each lens with respect to its corresponding pixel pair are configured such that the image of the line dividing its pixel pair intersects a perpendicular to the display surface at (or near) its center, with the images of all the dividing lines of all the pixel pairs intersecting that perpendicular at the common image point 116. It is understood that the lens elements need not be parallel to the corresponding pixel surface.

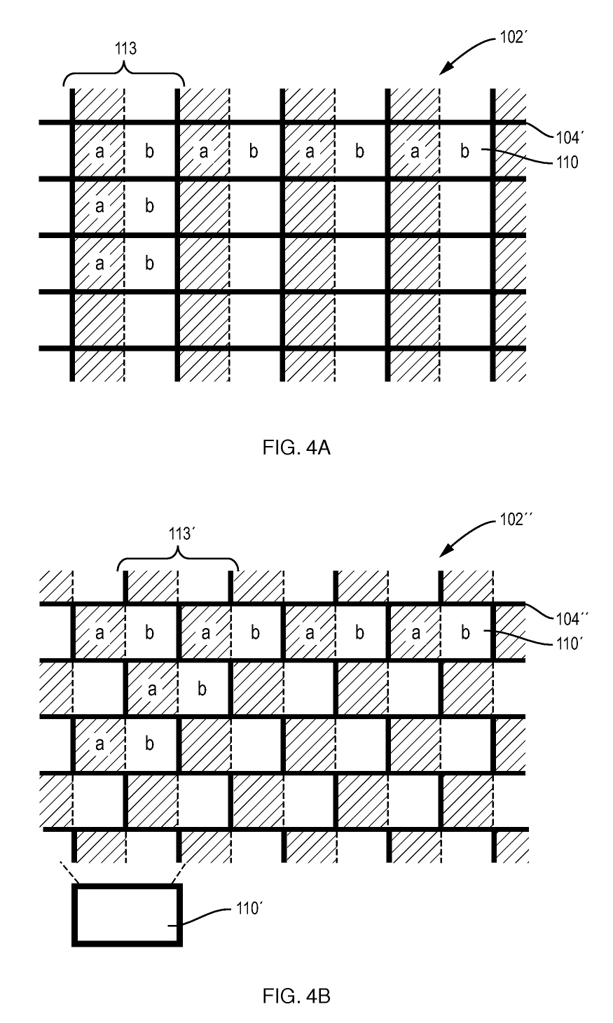

Then one of a viewer's eyes, located to one side of the perpendicular near that common image point, will see only the “a” pixels, and the other eye, located to the other side of the perpendicular near that common image point, will see only the “b” pixels. Since the images of the “a” and “b” pixels in the viewing region are reversed from their positions in the display, the “a” pixels on the left sides of the pixel dividing lines would be seen by the right eye, and the “b” pixels would be seen by the left eye. Thus one eye sees an image on the display formed by the “a” pixels while the other eye sees an image formed by the “b” pixels. Pixel pairs need not be aligned vertically; they can be staggered as shown in conjunction with FIG. 4B to correspond to the vertically staggered micro-lens array. That is, the “a” pixels (or the “b” pixels) need not be aligned in columns. The two groups of display pixels would need to be separately addressable so the display could be programmed to make those two display images constitute a stereo pair.

When a viewer is looking at the display and the viewer's eyes are positioned such that they are located on opposite sides of the common image point, the viewer will perceive a 3-D image. As indicated above, the viewer's head and eyes need not be restrained to a fixed position but can be moved horizontally a distance equal to the distance between the eyes with the 3-D view still seen by the viewer. If both of the viewer's eyes are moved to the viewing region on the same side of the surface perpendicular, the viewer will see a two-dimensional image; both eyes will see either the “a” display image only or the “b” display image only.

The set of “a” pixels and set of “b” pixels are separately addressable and are programmed so that the “a” pixels display one image of a stereo pair of images and the “b” pixels display the other image of a stereo pair of images, with the two sets of pixels interlaced on the screen. Then one eye will see only one of those images and the other eye will see only the other of those images. The signals communicated to the sets of “a” pixels and “b” pixels are produced using techniques known in the art. Since each lens element will reverse the relative locations of the pixel images in its corresponding pixel pair, the group of “a” pixels will display the right-eye image, and the group of “b” pixels will display the left-eye image, and the viewer will see a stereoscopic three-dimensional image.

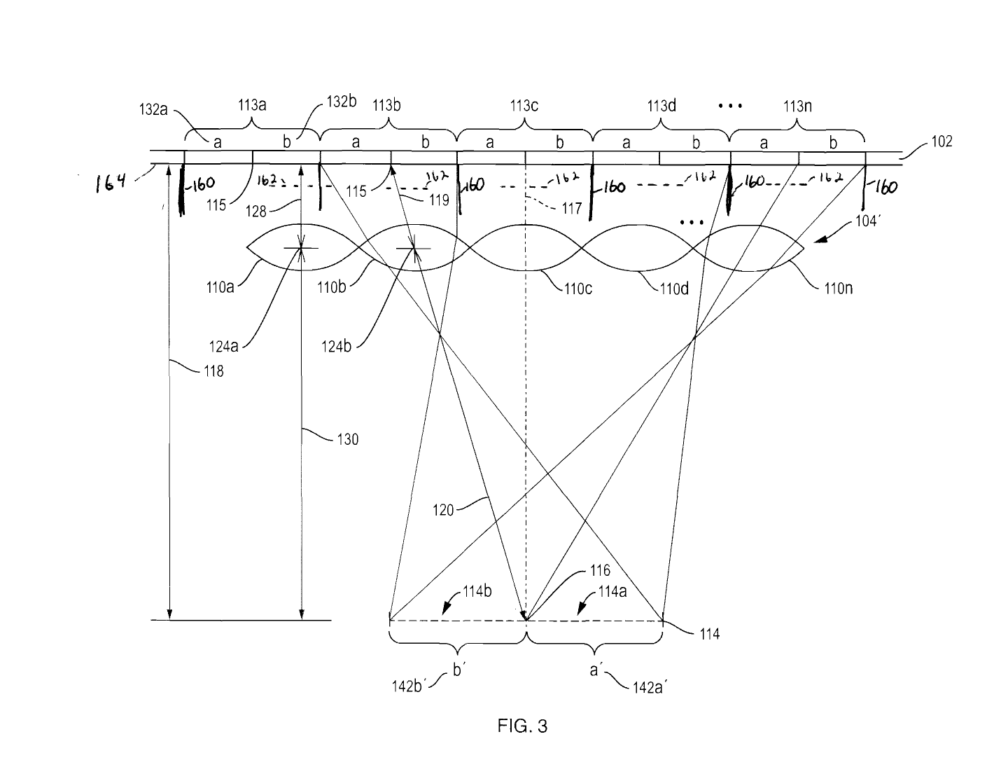

Referring now to FIG. 3, a portion of an exemplary autostereoscopic display apparatus 100 includes a row of pixels groups 113a-113n in the image display 102 and a corresponding elements 110a-110n in a row of lens elements 104′ of the micro-lens array 104. The elements 110a-110n are located in front of the corresponding pixel groups 113a-113n in a row of the image display 102. Each lens in the lens array is shaped, positioned, and oriented to form an image of a pair of horizontally-abutting pixels in the viewing region 114, such that the center of the boundary between pixels 115 of each pair of side-by-side pixels is imaged at a common image point 116 located along the perpendicular 117 from the display surface near its center. This results in a first viewing area 114a to be utilized by a viewer's right eye, and a second viewing area 114b to be utilized by that viewer's left eye. The perpendicular 117 need not intersect the pixel array or the lens array at a point of symmetry as shown, and the intersection points need not be located precisely at the pixel array or lens array centers. The optical center of each lens is located along a straight line extending between the center point of a pixel pair and the common image point 116. The distance 118 of the common image point 116 from the display surface is approximately the distance expected for a viewer to comfortably view the display screen. Thus, for example, the image of the side-by-side pixels 132a and 132b in group 113a produced by lens 110a includes the common image point 116, with the image 142a′ of pixel 132a located to the right side of the common image point 116 and the image 142b′ of pixel 132b located to the left side of the common image point 116.

A distance 119 of a given lens element from the center of the boundary between pixels 115 of the corresponding pixel group and a distance 120 from the lens element 110 to the common image point 116 are in the ratio required for the width of the image of a pixel in the viewing region to be at least the same as the distance between the viewer's eyes. The distance of the lens array from the screen will generally be much smaller than the distance of the viewer from the screen. Thus, if the viewer's right eye is located to the right of the common image point 116, that eye will see only the set of “a” pixels, and if the left eye is located to the left of the common image point 116, that eye will see only the set of “b” pixels.

Also, high-quality images of the boundaries between pixels 115 are not required. It is important, however, that the boundary images intersect at the common image point 116 reasonably close to the plane where the eyes are expected to be located. This is accomplished by appropriately positioning and orienting each lens.

One way to accomplish this is to keep all the lenses parallel to each other in a plane (or to locate them on a non-planar surface that accommodates or conforms to the shape of the display surface) and to simply shift the position of each lens appropriately. In one embodiment, elements 110 of the micro-lens array 104 are disposed on a non-planar surface that conforms to the shape of the front surface of the image display. The outer shape of each lens may conform to the shape of the pair of pixels behind it, e.g., a rectangular lens for a pair of rectangular pixels, but it is not required to do so. Depending on the parameters chosen for the different lenses, they can have different outer shapes to allow them to remain close to each other and minimize dead space between adjacent lenses or to satisfy other requirements (e.g., to facilitate manufacturing).

In one embodiment, each lens is slightly smaller than its corresponding pixel pair, and the overall lens array is slightly smaller than the overall pixel array. FIG. 3 shows the optical center 124b of lens 110b located along a straight line 119 and 120 extending between the center point of a pixel pair and the common image point 116.

In another embodiment, at least two elements 110 in the micro-lens array 104 have a differing fixed optical property as a function of the distance from an object plane including the boundary between pixels 115 to a corresponding element 110 of the micro-lens array 104, and an image-plane distance from the corresponding element 110. In this embodiment, the optical property is the focal length of each lens element 110a-110n. For example, as an approximation, the thin lens equation is used to configure the focal length of each lens element 110a-110n. That equation is

1/f=1/p+1/q, (1)

where f is the focal length of the lens, p is the distance of the object plane (including the pixel-pair dividing line) from the lens, and q is the image-plane distance from the lens.

A given pixel group 113 in the pixel array of the display 102 and a lens element 110 can be identified by coordinates i and j, row and column respectively. With this notation, the focal length of the lens for a given pixel pair is denoted by fᵢⱼ; the perpendicular distance of the object plane including the pixel dividing line center to the optical center of the lens element is denoted by pᵢⱼ; the perpendicular distance of the image plane to the optical center of the lens element is denoted by qᵢⱼ; and Eq. (1) becomes:

1/fᵢⱼ=1/pᵢⱼ+1/qᵢⱼ, (2)

where subscript i represents the lens element row location; and subscript j represents the lens element column location. For a given pixel-pair group, lens element and distance between the display and viewer, combinations of values that satisfy Equation (2) can be chosen.

Referring again to FIG. 3, for element 110a in column a, pᵢₐ (the distance from an object plane including the pixel group dividing line 115 to a center point 124a of element 110a) in row i and column a is indicated by line 128 along the optical axis and qᵢₐ (image-plane distance from the center point 124a) is indicated by line 130 along the optical axis. In one embodiment, in order to provide an improved 3-D effect, a fixed optical property, for example, the orientation of an element 110 with respect to the object plane or the focal length of an element can vary between elements. For example, element 110a can be rotated horizontally to provide an improved display. It is understood that the element 110a could also be rotated vertically as a function of the row i and column j position in the micro-lens array 104.

In one embodiment, a computer display 102 has dimensions 30 centimeters wide and 24 centimeters high, and a viewing distance (the distance to the common image point 116 from the display center) of 50 centimeters. In smaller displays, for example, a cell phone, a handheld wireless Internet device or game player, the viewing distance is considerably less, and slightly less for devices such as a portable DVD player or personal TV. In this embodiment, the value of qᵢⱼ is nominally 50 cm for i and j in the center of the display. With this configuration, a viewer's head can move horizontally a distance equal to the distance between the eyes while still perceiving the 3-D view. Each eye should be able to see its corresponding set of pixels “a” or “b” over a horizontal distance at least equal to the eye separation, which is on average approximately 6.3 cm. If a pixel is assumed to be square with dimension of approximately 0.5 mm, or 0.05 cm, then the required magnification is approximately 126, giving a value of pᵢⱼ equal to about 0.4 cm. Equation (2) provides:

fᵢⱼ=pᵢⱼqᵢⱼ/(pᵢⱼ+qᵢⱼ). (3)

The values pᵢⱼ=0.4 cm and qᵢⱼ=50 cm give fᵢⱼ=0.4 cm. This is an approximate value. The focal length fᵢⱼ must actually be a bit smaller than 0.4 cm, the value of pᵢⱼ. If pᵢⱼ were exactly equal to fᵢⱼ, the image of the pixel dividing line would be at qᵢⱼ=∞. The outer dimensions of each lens can be about the same or smaller than the overall pixel-pair dimensions.

For clarity, FIGS. 4A and 4B show each lens element 110 and 110′, respectively, aligned with the corresponding pixel pair and having the same size as the corresponding pixel pair. However, the lens elements 110 and 110′ are not necessarily aligned exactly with the corresponding pixel groups 113 and 113′, respectively. The outer dimensions of each lens element 110 and 110′ can be approximately the same or smaller than the overall pixel group 113 and 113′ dimensions. In one embodiment, each lens 110 and 110′ is slightly smaller than its corresponding pixel pair 113 and 113′, and the overall lens arrays 104′ and 104″ are slightly smaller than the overall pixel array.

Now referring to FIG. 4A, the elements 110 of a micro-lens array 104′ (similar to micro-lens array 104) are aligned both horizontally and vertically in front of display 102′. FIG. 4B shows an embodiment in which the elements 110′ of a micro-lens array 104″ are disposed in a staggered fashion in a vertical direction with respect to an adjacent row in front of display 102″. Vertical staggering of the lens elements 110′ (FIG. 4B) reduces imbalance between horizontal and vertical resolutions. It will be appreciated that single-row, multiple-row or other staggering configurations of the lens elements 110′ are also possible, to further equalize horizontal and vertical resolutions.

In another embodiment, the elements 110′ of the micro-lens array 104″ are disposed in a staggered fashion in a vertical direction in groups. That is, referring to FIG. 4B, in two or more abutting rows the elements 110′ of the micro-lens array 104″ are aligned vertically; in the next group of the same number of two or more abutting rows the elements 110′ of the micro-lens array 104″ are aligned vertically but that group is shifted relative to the first group of rows by the width of one pixel, and so on.

In conventional lenticular systems, the cylindrical lenses cannot be staggered vertically. When a pixel-based display is used to provide two stereoscopic images instead of a single 2D image, the number of pixels available for each of the two stereo images is half of the total number of pixels. Therefore the overall resolution of each of the two images is half the 2D image. If the lenses are not staggered, then a vertical column of pixels seen by the viewer in each stereo image is continuous and unchanged from its 2D version. For a given eye, alternate columns are missing, but the vertical columns that are seen have the same resolution as in the 2D display. The horizontal rows of pixels, however, are of necessity staggered. This imbalance between horizontal and vertical resolutions can be visually uncomfortable. This imbalance is avoided in embodiments of the present invention by staggering the lens elements as described above so that the vertical stacks of pixels are not all lined up vertically. The staggering of the lens elements in these embodiments alternates the vertical pixels seen by a given eye to match the horizontal staggering.

Referring again to FIG. 4A and FIG. 4B, the lens elements 110 and 110′, respectively, are shown having rectangular shapes. In one alternate embodiment a differing fixed optical property of the lens elements is the shape of the elements, and for example, the lens elements 110 and 110′ can have a rectangular shape having varying dimensions as a function of each element position in the micro-lens arrays 104′ and 104″. It is understood that the elements can also have other shapes as long as the imaging requirements discussed above are satisfied, for example, the center of the pixel pair is imaged at the common image point 116. Alterations in the lens element shape can be made to facilitate manufacturing.

Embodiments discussed herein can be applied to a portion of a display screen rather than to the entire display screen. When applied to only a portion of a display screen, it is understood that, for example, references to the perpendicular from at or near the center of the display screen means from at or near the center of the portion of the display screen covered by the micro-lens array.

### Depth of Field

To some extent, the viewer's head can move either closer to the display screen or farther from the screen than the location of the common image point 116 and retain 3-D viewing. The distances that the viewer's head can move depend on the angular spread of rays from the pixels located farthest from the display center. Since the lenses are small compared with their distances from the common image point 116, the angular spread of rays from a given dividing line and lens will be relatively small, but, as the head is moved perpendicular to the screen, the overall width of the region occupied by the group of all dividing line rays increases more rapidly than does the width from a single pixel. That overall angular spread determines the separation between the regions from which one eye sees only the “a” pixels and the other eye sees only the “b” pixels. Thus the range of allowed viewing distances varies with display screen size and viewing distance.

### Color Display

The display apparatus is not limited to monochromatic or black-and-white displays. It will work with a display in which each pixel is of a single color—any color. However, many displays contain within each pixel three distinct stripes, or bands (sometimes called “sub-pixels”), each of a different color (generally red, green, and blue). Those displays depend on the brain's ability to mix the colors; the relative intensities of the three colors in a given pixel are adjusted for the viewer to perceive the intended brain-averaged single color. If in the present invention such a color pixel were to be accurately imaged where the eyes are located, each eye would tend to see only one of those color bands, with the observed color depending on the head position. To overcome this effect, a diffuser sheet can be used to achieve the intended averaged color. In one embodiment, the diffuser sheet is disposed between the image display and the micro-lens array to mix the outputs of each set of RGB pixels. In this embodiment, the thickness of the diffuser sheet is small relative to the distance between the lens array and the display surface. The diffuser sheet is placed in front of and close to the display surface and is constructed with separated diffusing regions, one diffusing region for each pixel. Those diffusing regions would be separated by light barriers to prevent light from crossing from one diffusing region to any adjacent region. Thus only the colors within a single pixel would be mixed to effectively replace the color-striped pixel with one of the single color intended to be viewed at that location on the display screen. The thickness of the diffuser sheet, placement of light barriers between diffuser sheets, and the proximity of the diffuser sheet to the display surface can be varied to improve optical performance. In one alternative embodiment, each color segment of each pixel is treated as a separate pixel with its own separate lens element. It is understood that for a color display, reference to pixels in this description means the diffused pixels.

### Switching Between 3-D and 2-D Viewing

There are two ways to view a two-dimensional picture on the invention's three-dimensional display. One way is to locate both eyes on the same side of the common image point 116. The second way is to provide for switching electrically either the “a” set of pixels or the “b” set to display additional pixels corresponding to the picture being presented by the other set. Then both sets of pixels would display the same picture. Thus the display system can be switched easily and reversibly between 3-D and 2-D viewing.

Although certain embodiments are described as an add-on to an available display, they can be built into a display. That can be done in its entirety or in part. For example, only the diffusing sheet might be built in, which would not impede normal viewing of the display alone and would allow the lens array to be an add-on. It is understood that embodiments of the invention can provide 3-D viewing of both dynamic and static (e.g., printed) pictures that can be represented by a stereo pair of images.

In another embodiment, non-reflecting light barriers (not shown) extending from the display surface between adjacent pixel pairs to the boundaries of associated lenses are included to reduce light from the pixels associated with a given lens reaching another lens and being directed to locations outside the intended viewing area.

In another embodiment, the lenses in the lens array are all constructed the same size and with identical optical parameters, allowing for a uniform micro-lens array. In this case, each lens element would be slightly smaller than a pixel group and the overall dimensions of the micro-lens array would be slightly smaller than the dimensions of the overall display surface.

Another embodiment (not shown) places a lens in front of each pixel instead of in front of a pair of pixels or group of pixels. In this embodiment, each pixel is imaged independently to one side or the other of the common image point 116 so that that pixel can be seen by only one eye when the viewer's head is in its expected viewing location. Since in this embodiment the part of each object to be imaged at the common image point 116 would be an object edge rather than a point near its center, higher-quality optics are required. Also, twice as many smaller lenses would be required.

Yet another embodiment (not shown) provides a separate lens for each color region within each color pixel group, eliminating the need for a diffuser sheet for a color display. Such an approach requires a greater number of smaller lenses.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. An autostereoscopic display apparatus comprising:
an image display for providing a display output comprising a plurality of pixels grouped in a row and column array;
a micro-lens array disposed adjacent the image display, having a plurality of elements directing outputs from respective pixel groups into different respective viewing areas so as to enable a stereoscopic image to be perceived; and
wherein at least two elements in the micro-lens array have a differing fixed optical property as a function of a distance from an object plane including a pixel group dividing line to a center point of the corresponding element of the micro-lens array along the optical axis, and an image-plane distance from the corresponding element.

2. The autostereoscopic display of claim 1, wherein the elements of the micro-lens array are disposed on a non-planar surface that conforms to the shape of a front surface of the image display.

3. The autostereoscopic display of claim 1, wherein the pixel group is a pixel pair.

4. The autostereoscopic display of claim 1, wherein the pixel group is a set of RGB pixels.

5. The autostereoscopic display of claim 4, further comprising a diffuser sheet disposed between the image display and the micro-lens array to mix the outputs of each set of RGB pixels.

6. The autostereoscopic display of claim 1, wherein the differing fixed optical property is a focal length of an element.

7. The autostereoscopic display of claim 6, wherein the focal length of the element is determined approximately by fᵢⱼ=pᵢⱼqᵢⱼ/(pᵢⱼ+qᵢⱼ), where:
f is the focal length;
i is a row index and j is a column index of the pixel groups and corresponding lenses;
pᵢⱼ represents the distance from the object plane including the pixel group dividing line center to the optical center of the element of the micro-lens array corresponding to the pixel group in the row and column array; and
qᵢⱼ represents the distance from the image plane to the optical center of the corresponding element.

8. The autostereoscopic display of claim 1, wherein the differing fixed optical property is a shape of the element.

9. The autostereoscopic display of claim 1, wherein the differing fixed optical property is an orientation of an element with respect to the object plane.

10. The autostereoscopic display of claim 1 further comprising a plurality of non-reflecting light barriers extending from the display surface between adjacent pixel pairs to the boundaries of corresponding elements of the micro-lens array, wherein the light barriers substantially eliminate light from the plurality of pixels reaching an element other than the corresponding element.

11. The autostereoscopic display of claim 1 wherein the elements of the micro-lens array are disposed in a staggered fashion in a vertical direction with respect to an adjacent row.

12. The autostereoscopic display of claim 1 wherein the image provided by the image display is located off of the focal plane of elements of the micro-lens array.

13. A 3-D display comprising:
an array of pixel pairs, each pixel pair including at least one first pixel and at least one second pixel;
an array of lenses disposed in front of the array of pixel pairs, each lens in the array of lenses in optical alignment with a respective pixel pair and configured with a focal pattern such that a first image of a first pixel of one of the pixel pairs is projected into a first viewing area and a second image of a second pixel of the same one of the pixel pairs is projected into a second viewing area;
the first viewing area being a first location for viewing by a respective one of a viewer's left and right eye and the second viewing area being a second location for viewing by the viewer's other eye.

14. The 3-D display of 13 wherein the array of pixel pairs and corresponding lenses are provided in a staggered arrangement.

15. The 3-D display of 13 wherein signals sent to each first pixel of each pixel pair collectively combine to form an image viewed by a right eye of the viewer, and signals sent to each second pixel of each pixel pair collectively form an image viewed by a left eye of the viewer.

16. A method for presenting a three dimensional (3-D) display comprising:
providing a micro-lens array having a plurality of elements directing the outputs from respective pixel groups into different respective viewing areas and wherein at least two elements in the micro-lens array have a differing fixed optical property as a function of the distance of an object plane including a pixel group dividing line center from a corresponding element of the micro-lens array, and an image-plane distance from the optical center of the corresponding element; and
providing an stereoscopic image disposed proximate to the micro-lens array, wherein the image provides a first eye perspective view and a second eye perspective view.

17. The method of claim 16, wherein the differing fixed optical property is a focal length of an element.

18. The method of claim 17, wherein the focal length of the element is determined approximately by fᵢⱼ=pᵢⱼqᵢⱼ/(pᵢⱼ+qᵢⱼ), where:
f is the focal length;
i is a row index and j is a column index of the pixel groups and corresponding lenses;
pᵢⱼ represents the distance from the object plane including the pixel group dividing line center to the optical center of the element of the micro-lens array corresponding to the pixel group in the row and column array; and
qᵢⱼ represents the distance from the image plane to the optical center of the corresponding element.

19. The method of claim 16 further comprising staggering the pixels groups and corresponding elements in the micro-lens array.

20. The method of claim 16, wherein the elements of the micro-lens array are disposed on a non-planar surface that conforms to the shape of a front surface of the image display.

21. The autostereoscopic display of claim 1, wherein the optical characteristics of each element of the micro-lens array are substantially rotationally symmetric about the optical axis of each lens element.

22. The autostereoscopic display of claim 12, wherein the focal plane of the micro-lens array is located in front of a front surface of the image display.

23. The method of claim 16 further comprising aligning each element of the micro-lens array to provide a viewing region which allows movement of the viewer's head to move horizontally a distance approximately equal to the distance between the eyes while still allowing the viewer to perceive the stereoscopic image in 3-D.

24. The method of claim 23 wherein aligning each element of the micro-lens array further allows movement of the viewer's head to move vertically while still allowing the viewer to perceive the stereoscopic image in 3-D.

25. The autostereoscopic display of claim 1, wherein each of the plurality of pixel groups is aligned one-to-one with a corresponding element of the micro-lens array.

26. The autostereoscopic display of claim 1, wherein each respective viewing area is a rectangular viewing area.

27. The autostereoscopic display of claim 25, wherein the plurality of pixel groups and corresponding elements of the micro-lens array are provided in a staggered arrangement.

28. The autostereoscopic display of claim 25, wherein the distances between the optical centers of the elements of the micro-lens array are smaller than the distances between the centers of the corresponding pixel groups such that images of pixel groups overlap in the respective viewing areas.
